(19) United States
(12) Patent Application Publication
(10) Pub. No.: US 2026/0091947 A1
(43) Pub. Date: Apr. 2, 2026

(54) ROLL SUBSTRATE HOLDING DEVICE, ROLL SUBSTRATE HOLDING METHOD, AND PRINTING APPARATUS

(71) Applicant: FUJIFILM Corporation, Tokyo (JP)

(72) Inventors: Noriaki MAIDA, Kanagawa (JP); Shoichi TAKAYA, Kanagawa (JP)

(73) Assignee: FUJIFILM Corporation, Tokyo (JP)

(21) Appl. No.: 19/370,657

(22) Filed: Oct. 27, 2025

Related U.S. Application Data
(63) Continuation of application No. PCT/JP2024/014946, filed on Apr. 15, 2024.

(30) Foreign Application Priority Data
May 10, 2023 (JP) 2023-077964

(51) Int. Cl. B65H 16/06

(52) U.S. Cl. CPC B65H 16/06; B65H 2301/41346; B65H 2301/41352; B65H 2301/413686; B65H 2301/41369; B65H 2801/03

(57) ABSTRACT

A roll substrate holding device has improved versatility of a winding core and sufficient holing strength. The roll substrate holding device that holds a roll substrate wound around a winding core without a shaft includes: a holding member that is inserted into an opening of a first winding core having a first inner diameter and that comes into contact with the first winding core to rotatably hold the first winding core; and a conversion adapter that is mounted in an opening of a second winding core having a second inner diameter larger than the first inner diameter, wherein the holding member is inserted into an opening of the conversion adapter that is mounted in advance on the second winding core, and comes into surface contact or line contact with an inner peripheral surface of the conversion adapter having the first inner diameter to rotatably hold the second winding core.

### CROSS-REFERENCE TO RELATED APPLICATIONS

The present application is a Continuation of PCT International Application No. PCT/JP2024/014946 filed on Apr. 15, 2024 claiming priority under 35 U.S.C § 119(a) to Japanese Patent Application No. 2023-077964 filed on May 10, 2023. Each of the above applications is hereby expressly incorporated by reference, in its entirety, into the present application.

### BACKGROUND OF THE INVENTION

### 1. Field of the Invention

The present invention relates to a roll substrate holding device, a roll substrate holding method, and a printing apparatus, and particularly relates to a technique of holding a roll substrate wound around a winding core.

### 2. Description of the Related Art

A printer that transports a roll substrate wound around a winding core by using a roll-to-roll method and records an image is known. In such a printer, in a case where both ends of the winding core are held without using a shaft, an inner diameter of the winding core becomes an issue. For example, in a printer designed for a roll substrate with a 3-inch winding core, a 6-inch winding core cannot be used.

In response to such an issue, JP2003-276911A discloses a roll-shaped recording medium holding device comprising a shaft to be inserted into a hollow shaft portion of a roll-shaped recording medium, pressing portions that are fitted to both end portions of the hollow shaft portion of the roll-shaped recording medium into which the shaft is inserted and that press the roll-shaped recording medium, and an adapter that is attached to the pressing portion and fitted into the hollow shaft portion of the roll-shaped recording medium in a case where an inner diameter of the hollow shaft portion of the roll-shaped recording medium is different.

### SUMMARY OF THE INVENTION

In the holding device disclosed in JP2003-276911A, a locking hole is formed in a roll paper supporting member, and a locking claw formed on one end surface of the adapter is locked into the locking hole. Therefore, in a case where an outer diameter of the roll substrate is large or in a case where a transport speed is high, there is a problem in that strength of the adapter is insufficient.

With respect to this, in a case where the adapter is designed to be secured with screws in order to ensure strength, the ease of switching the roll substrate is lost, and a problem arises in that an area occupied by the adapter becomes larger.

The present invention has been made in view of such circumstances, and an object of the present invention is to provide a roll substrate holding device, a roll substrate holding method, and a printing apparatus that improve general-purpose properties of a winding core and that hold a roll substrate with sufficient strength.

In order to achieve the above object, according to a first aspect of the present disclosure, there is provided a roll substrate holding device that holds a roll substrate wound around a winding core without using a shaft, the roll substrate holding device comprising: a holding member that is inserted into an opening of a first winding core having a first inner diameter and that comes into contact with the first winding core to rotatably hold the first winding core; and a conversion adapter that is mounted in an opening of a second winding core having a second inner diameter larger than the first inner diameter, in which an inner diameter of an opening of the conversion adapter is the first inner diameter, and the holding member is inserted into the opening of the conversion adapter that is mounted in advance on the second winding core, and comes into surface contact or line contact with an inner peripheral surface of the conversion adapter having the first inner diameter to rotatably hold the second winding core.

According to the first aspect, the general-purpose properties of the winding core can be improved and the roll substrate can be held with sufficient strength.

According to a second aspect of the present disclosure, in the roll substrate holding device according to the first aspect, the conversion adapter has a flange portion provided around an entire circumference of an end portion, and an outer diameter of the flange portion is larger than the second inner diameter. Accordingly, it is possible to prevent the conversion adapter from being inserted into the second winding core.

According to a third aspect of the present disclosure, in the roll substrate holding device according to the first or second aspect, it is preferable that the outer diameter of the flange portion be larger than an outer diameter of the holding member. Accordingly, in a case where the conversion adapter and the second winding core are seized together, the conversion adapter can be easily removed from the second winding core.

According to a fourth aspect of the present disclosure, it is preferable that the roll substrate holding device according to any one of the first to third aspects further comprise: an attachment/detachment mechanism that moves the holding member in an axial direction of the second winding core between a mounting position where the holding member is inserted into the opening of the conversion adapter and a retracted position where the holding member is retracted from the opening of the conversion adapter; and a restricting member that restricts movement of the conversion adapter in a case where the holding member is moved from the mounting position to the retracted position. Accordingly, movement of the conversion adapter can be restricted.

According to a fifth aspect of the present disclosure, in the roll substrate holding device according to the fourth aspect, it is preferable that the restricting member have one end abutting on a frame and the other end abutting on the conversion adapter and restricts movement of the conversion adapter, and that a length of the restricting member in the axial direction be shorter than a distance between the frame and the holding member in the mounting position, and is longer than a distance between the holding member and the frame in the retracted position. Accordingly, movement of the conversion adapter to the retracted position can be restricted.

According to a sixth aspect of the present disclosure, in the roll substrate holding device according to the fourth or fifth aspect, it is preferable that the restricting member include one or more and four or less rod-shaped members extending in the axial direction.

According to a seventh aspect of the present disclosure, in the roll substrate holding device according to the fourth or fifth aspect, it is preferable that the restricting member include a tubular member extending in the axial direction and covering the holding member.

According to an eighth aspect of the present disclosure, in the roll substrate holding device according to any one of the fourth to seventh aspects, it is preferable that the restricting member be a resin member or a metal member.

According to a ninth aspect of the present disclosure, in the roll substrate holding device according to any one of the fourth to eighth aspects, it is preferable that the restricting member be fixed to the frame.

According to a tenth aspect of the present disclosure, in the roll substrate holding device according to any one of the fourth to eighth aspects, it is preferable that the restricting member be integrated with the conversion adapter.

According to an eleventh aspect of the present disclosure, in the roll substrate holding device according to any one of the fourth to tenth aspects, it is preferable that the holding member include a mechanical chuck that brings a pressing member into pressure contact with an inner peripheral surface of the first winding core.

According to a twelfth aspect of the present disclosure, in the roll substrate holding device according to any one of the fourth to eleventh aspects, it is preferable that the roll substrate holding device be provided with a pair of the holding members that are inserted into openings at both ends of the first winding core, and a pair of the conversion adapters that are mounted in the openings at both ends of the first winding core.

In order to achieve the above object, according to a thirteenth aspect of the present disclosure, there is provided a printing apparatus that transports a substrate by using a roll-to-roll method, the printing apparatus comprising: the roll substrate holding device according to any one of the first to twelfth aspects; and a jetting device that jets ink from an ink jet head onto the substrate to print an image.

According to the thirteenth aspect, the general-purpose properties of the winding core can be improved and the roll substrate can be held with sufficient strength.

In order to achieve the above object, according to a fourteenth aspect of the present disclosure, there is provided a roll substrate holding method of holding a roll substrate wound around a winding core without a shaft, the roll substrate holding method comprising: a step of mounting a conversion adapter in an opening of a second winding core having a second inner diameter larger than a first inner diameter; and a step of inserting, into an opening of the conversion adapter that is mounted in advance on the second winding core, a holding member that is inserted into an opening of a first winding core having the first inner diameter and that comes into contact with the first winding core to rotatably hold the first winding core, and bringing the holding member into surface contact or line contact with an inner peripheral surface of the conversion adapter having the first inner diameter to rotatably hold the second winding core.

According to the fourteenth aspect, the general-purpose properties of the winding core can be improved and the roll substrate can be held with sufficient strength.

According to the present invention, the general-purpose properties of the winding core can be improved and the roll substrate can be held with sufficient strength.

### BRIEF DESCRIPTION OF THE DRAWINGS

FIG. 1 is a diagram showing an example of a printing apparatus.

FIG. 2 is a schematic diagram of a roll substrate holding device.

FIGS. 3A to 3C are diagrams for describing a configuration and an operation of a chuck device.

FIGS. 4A and 4B are diagrams showing a conversion adapter.

FIGS. 5A and 5B are diagrams for describing mounting of the conversion adapter.

FIG. 6 is a diagram showing a state in which the roll substrate holding device holds a second paper tube.

FIGS. 7A to 7C are diagrams for describing an operation of the chuck device in a case where the second paper tube is held.

FIG. 8 is a diagram showing a state in which an adapter is not detached from a holding member.

FIGS. 9A to 9C are diagrams for describing a configuration and an action of a tension rod.

### DESCRIPTION OF THE PREFERRED EMBODIMENTS

Hereinafter, a preferred embodiment of the present invention will be described in accordance with the accompanying drawings.

### <Configuration of Ink Jet Printing Apparatus>

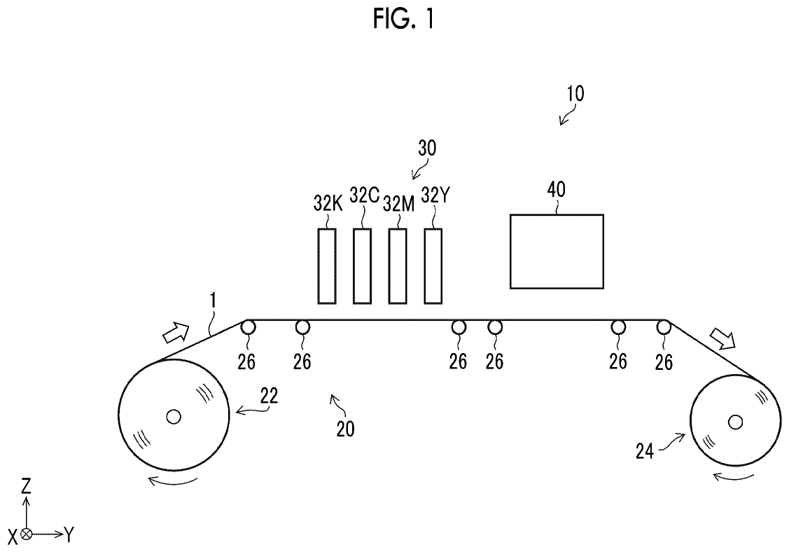

FIG. 1 is a diagram showing an example of a printing apparatus. An ink jet printing apparatus 10 shown in FIG. 1 is a printer that transports a long substrate 1 by using a roll-to-roll method and that prints an image by using a single-pass method.

The substrate 1 is a transparent film substrate used for soft packaging. The term “soft packaging” refers to packaging formed of a material that deforms depending on a shape of an article to be packaged. The term “transparent” refers to having a visible light transmittance equal to or higher than 30% and equal to or lower than 100%, preferably a visible light transmittance equal to or higher than 70% and equal to or lower than 100%. The substrate 1 may be, for example, oriented nylon (ONY), oriented polypropylene (OPP), or polyethylene terephthalate (PET).

As shown in FIG. 1, the ink jet printing apparatus 10 comprises a transport unit 20, a jetting unit 30, and a drying unit 40.

The transport unit 20 includes an unwinding unit 22, a winding unit 24, and a plurality of pass rollers 26. The unwinding unit 22 is an unwinding mechanism that unwinds the substrate 1 before printing that is wound in a roll shape. In addition, the winding unit 24 is a winding mechanism that winds the substrate 1 after printing in a roll shape. The transport unit 20 transports the substrate 1 by using a roll-to-roll method while guiding the substrate 1 by the plurality of pass rollers 26 along a transport path from the unwinding unit 22 to the winding unit 24. The substrate 1 may be transported in a state where tension is applied thereto.

The jetting unit 30 and the drying unit 40 are disposed on the transport path of the substrate 1.

The jetting unit 30 comprises ink jet heads 32K, 32C, 32M, and 32Y. The ink jet heads 32K, 32C, 32M, and 32Y are each a line-type recording head that can perform printing on the substrate 1 transported by the transport unit 20 in one scan.

The ink jet heads 32K, 32C, 32M, and 32Y jet color inks of black (K), cyan (C), magenta (M), and yellow (Y), respectively. Each color ink is an aqueous ink obtained by dissolving or dispersing water and a coloring material, such as a dye and a pigment, in a solvent soluble in water. A corresponding color ink is supplied to each of the ink jet heads 32K, 32C, 32M, and 32Y from an ink tank (not shown) via a pipe path (not shown).

The ink jet heads 32K, 32C, 32M, and 32Y are disposed such that their nozzle surfaces (not shown) face the transport path of the substrate 1. A plurality of nozzles (not shown), which are outlets of color inks, are two-dimensionally arranged on each of the nozzle surfaces of the ink jet heads 32K, 32C, 32M, and 32Y.

The ink jet heads 32K, 32C, 32M, and 32Y are disposed at regular intervals along the transport path of the substrate 1. The ink jet heads 32K, 32C, 32M, and 32Y may be configured by connecting a plurality of head modules in a width direction of the substrate 1.

The jetting unit 30 (an example of a “jetting device”) jets droplets of color inks from at least one of the ink jet heads 32K, 32C, 32M, and 32Y onto a printing surface of the substrate 1 transported by the transport unit 20 based on image data. The jetted droplets adhere to the printing surface of the substrate 1, thereby printing a color image on the printing surface of the substrate 1.

Here, a configuration using four color inks is illustrated, but the ink colors and the number of colors are not limited to the present embodiment. For example, an ink jet head may be added that jets pale color inks such as light magenta and light cyan, special color inks such as green, orange and violet, clear inks, and metallic inks. In addition, the order in which the ink jet heads of the respective colors are disposed is not limited.

The substrate 1 on which a color image has been printed by the jetting unit 30 is guided by the pass rollers 26 and is transported to the drying unit 40.

The drying unit 40 is a device that dries color inks on the printing surface of the substrate 1. The drying unit 40 comprises a plurality of hot air heaters (not shown). Each of the hot air heaters is disposed such that a blowing port (not shown) faces the printing surface of the substrate 1. Each of the hot air heaters functions as a heating device that blows hot air from the blowing port toward the printing surface of the substrate 1 to heat the substrate 1 and that dries the color inks adhering to the printing surface.

### <Configuration of Roll Substrate Holding Device>

### [Overall Configuration]

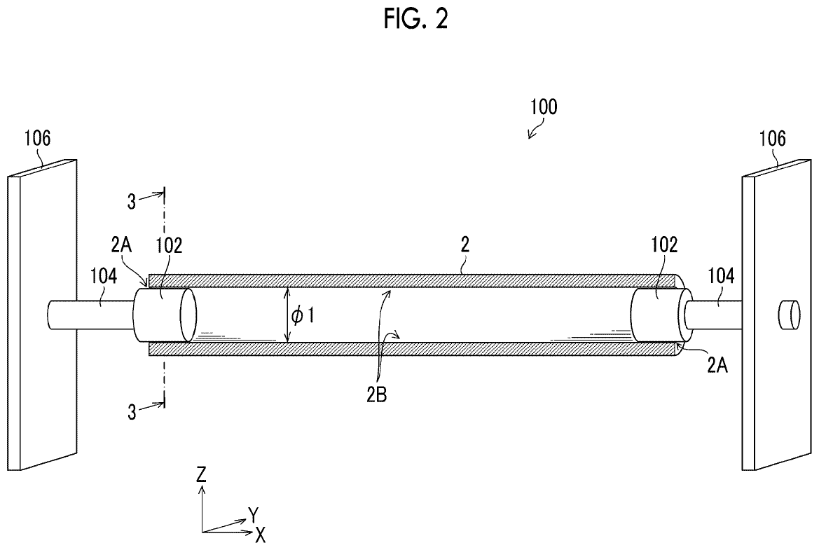

The unwinding unit 22 and the winding unit 24 each comprise a roll substrate holding device. FIG. 2 is a schematic diagram of a roll substrate holding device 100. The roll substrate holding device 100 is a device that holds the substrate 1 (an example of a “roll substrate”, not shown in FIG. 2) wound around a paper tube (an example of a “winding core”) without a shaft.

The roll substrate holding device 100 comprises a pair of holding members 102, a rotation and advance/retract mechanism 104, and a frame 106.

The pair of holding members 102 are inserted into openings 2A at both ends of a cylindrical first paper tube 2 (an example of a “first winding core”) having a first inner diameter (p 1. The holding members 102 come into surface contact with an inner peripheral surface 2B of the first paper tube 2 to rotatably hold the first paper tube 2. The holding members 102 may come into line contact with the inner peripheral surface 2B of the first paper tube 2 to rotatably hold the first paper tube 2.

The rotation and advance/retract mechanism 104 is connected to a motor (not shown) and rotates the holding member 102 about an axis parallel to an X direction. In addition, the rotation and advance/retract mechanism 104 is connected to an attachment/detachment mechanism (not shown) and advances or retracts the holding member 102 in the X direction.

The frame 106 is fixed to a floor surface (not shown) and supports the rotation and advance/retract mechanism 104.

### [Configuration and Operation of Holding Member]

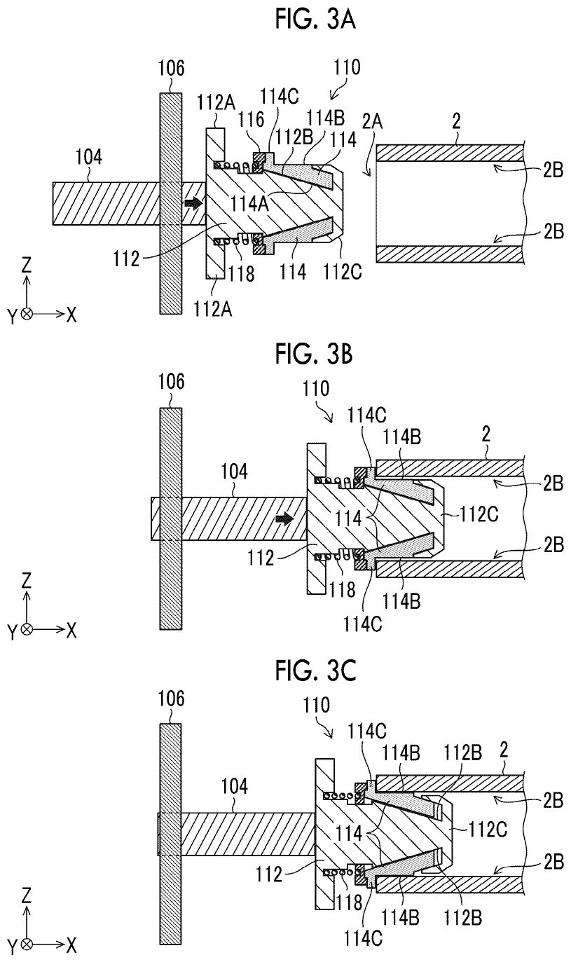

The holding member 102 comprises a mechanical chuck type chuck device. FIGS. 3A to 3C are diagrams for describing a configuration and an operation of a chuck device 110, and show a 3-3 cross section of FIG. 2. In the following description, the X direction parallel to a rotation shaft of the chuck device 110 will be referred to as an axial direction, and a direction perpendicular to the shaft will be referred to as a radial direction. In addition, a side of the chuck device 110 that is fixed to the rotation and advance/retract mechanism 104 in the axial direction will be referred to as a base end side, and a side opposite to the base end side in the axial direction will be referred to as a distal end side.

FIG. 3A shows a state before the chuck device 110 is inserted into the opening 2A of the first paper tube 2, and shows a state in which the chuck device 110 is in a retracted position where the chuck device 110 is retracted from the first paper tube 2. As shown in FIG. 3A, the chuck device 110 comprises a shaft 112, a lug 114, a receiving member 116, and a coil spring 118.

A flange 112A is provided at an end portion of the shaft 112 on the base end side. In addition, the distal end side of a side surface of the shaft 112 is provided with a tapered surface 112B that is inclined toward the center of the shaft as it extends to the distal end side. Further, a cap portion 112C is provided at an end portion of the shaft 112 on the distal end side.

The lug 114 is disposed at a position in contact with the tapered surface 112B of the shaft 112. A tapered surface 114A having the same taper angle as a taper angle of the tapered surface 112B is provided on a side of the lug 114 in contact with the shaft 112. In addition, an outer peripheral holding surface 114B parallel to the axial direction is provided on a side of the lug 114 opposite to the tapered surface 114A. Further, a flange 114C is integrally provided on the base end side of the lug 114.

FIGS. 3A to 3C show two lugs 114, but the number of the lugs 114 is not limited to two.

The receiving member 116 is an integral member surrounding the periphery of the shaft 112, and is disposed at a position where it abuts on a base end side surface of the flange 114C of each of a plurality of the lugs 114. Each of a plurality of the coil springs 118 is disposed at a position corresponding to the lug 114 and is compressed between the flange 114C of the lug 114 and the flange 112A of the shaft 112. Each of the coil springs 118 biases the lug 114 toward the cap portion 112C with a constant elastic force via the receiving member 116.

As shown in FIG. 3A, in a case where the chuck device 110 is in the retracted position, the first paper tube 2 is disposed with its axis center aligned with the axis center of the chuck device 110. From the state shown in FIG. 3A, the rotation and advance/retract mechanism 104 advances the chuck device 110 to the distal end side in the axial direction, and inserts the chuck device 110 into the opening 2A. FIG. 3B shows a state in which the chuck device 110 is inserted into the opening 2A and a distal end side surface of the flange 114C of the lug 114 abuts on an end surface of the first paper tube 2.

From the state shown in FIG. 3B, the rotation and advance/retract mechanism 104 further advances the chuck device 110 to the distal end side in the axial direction. In this case, since the flange 114C abuts on the end surface of the first paper tube 2, the lug 114 does not advance, and only the shaft 112 advances against the elastic force of the coil spring 118. Therefore, the lug 114 is expanded radially outward of the chuck device 110 along the tapered surface 112B and protrudes radially outward. The outer peripheral holding surface 114B of the lug 114 (an example of a “pressing member”) protruding radially outward comes into pressure contact with the inner peripheral surface 2B of the first paper tube 2. Accordingly, the lug 114 and the first paper tube 2 are fixed, and the chuck device 110 holds the first paper tube 2. FIG. 3C shows a state in which the chuck device 110 is in a mounting position where the chuck device 110 rotatably holds the first paper tube 2.

In a case of returning the chuck device 110 from the mounting position shown in FIG. 3C to the retracted position shown in FIG. 3A, the rotation and advance/retract mechanism 104 need only retract the chuck device 110 to the base end side in the axial direction.

Here, although only one of the pair of holding members 102 has been described, the same applies to the other holding member 102. The pair of holding members 102 can advance or retract in the axial direction, thereby aligning the axial center of the first paper tube 2 to a desired position.

Here, the holding member 102 comprising a mechanical chuck type chuck device has been described, but the holding member 102 may comprise an air chuck type chuck device that expands radially outward after being inserted into the opening 2A of the first paper tube 2 and that comes into pressure contact with the inner peripheral surface 2B of the first paper tube 2. In addition, the holding member 102 may comprise a tapered cone member having a tapered surface that expands in diameter from the distal end side to the base end side and that comes into surface contact or line contact with the inner peripheral surface 2B in a case where the distal end side is inserted into the opening 2A of the first paper tube 2.

### [Conversion Adapter]

The roll substrate holding device 100 comprises a pair of conversion adapters that are mounted in openings at both ends of a second paper tube having a second inner diameter φ2 larger than the first inner diameter φ1. Since the shapes of the pair of conversion adapters are the same, one conversion adapter will be described below.

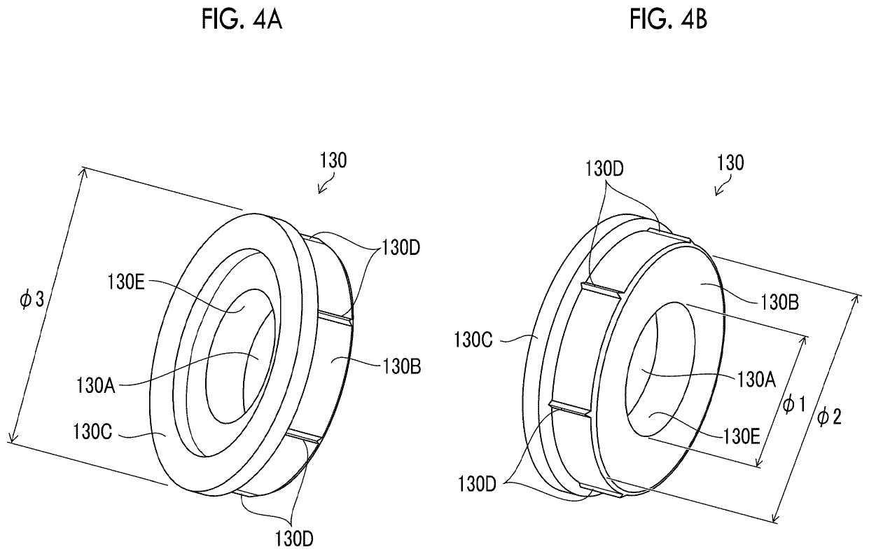

FIGS. 4A and 4B are diagrams showing a conversion adapter 130. FIG. 4A is a front perspective view of the conversion adapter 130, and FIG. 4B is a rear perspective view of the conversion adapter 130.

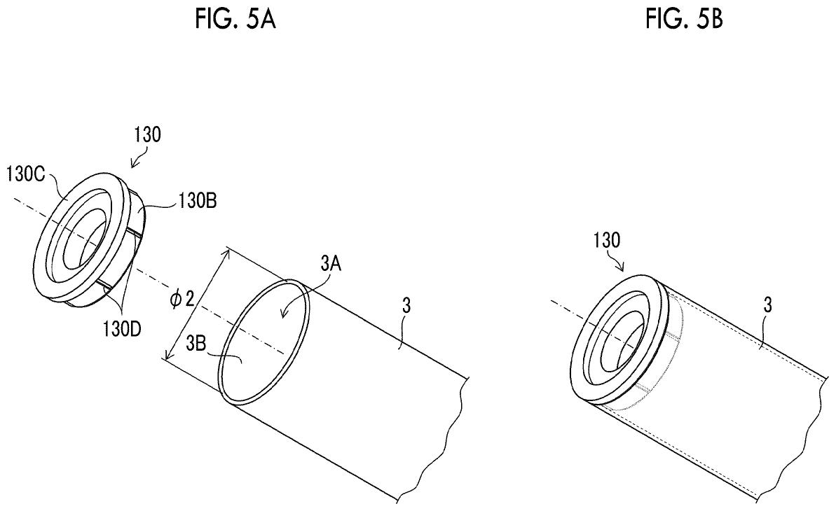

The conversion adapter 130 has a cylindrical portion 130B having openings 130A at both ends and an annular flange portion 130C. An inner diameter of the cylindrical portion 130B is φ1 and is equal to the first inner diameter φ1 of the first paper tube 2. In addition, an outer diameter of the cylindrical portion 130B is φ2 and is equal to a second inner diameter φ2 of a second paper tube 3 (see FIGS. 5A and 5B). Triangular mountain-like protrusions 130D are provided on an outer peripheral surface of the cylindrical portion 130B at equal intervals in parallel to the axial direction of the cylindrical portion 130B.

The flange portion 130C protrudes radially outward from the cylindrical portion 130B around the entire circumference of one end portion of the cylindrical portion 130B in the axial direction. An outer diameter φ3 of the flange portion 130C is larger than the second inner diameter φ2 of the second paper tube 3.

FIGS. 5A and 5B are diagrams for describing mounting of the conversion adapter 130. FIG. 5A shows one opening 3A of a cylindrical second paper tube 3 (an example of a “second winding core”) having the second inner diameter φ2. In addition, FIG. 5B shows the conversion adapter 130 mounted in the opening 3A of the second paper tube 3. In the state shown in FIG. 5B, the cylindrical portion 130B of the conversion adapter 130 is inserted into the opening 3A of the second paper tube 3, and the triangular mountain-like protrusions 130D are brought into pressure contact with the inner peripheral surface 3B of the second paper tube 3. Therefore, the conversion adapter 130 is fitted and fixed to the opening 3A of the second paper tube 3. In addition, the flange portion 130C of the conversion adapter 130 abuts on an end surface of the second paper tube 3. Therefore, the conversion adapter 130 is prevented from being entirely inserted into the second paper tube 3.

### [Roll Substrate Holding Device in Case of Holding Second Paper Tube]

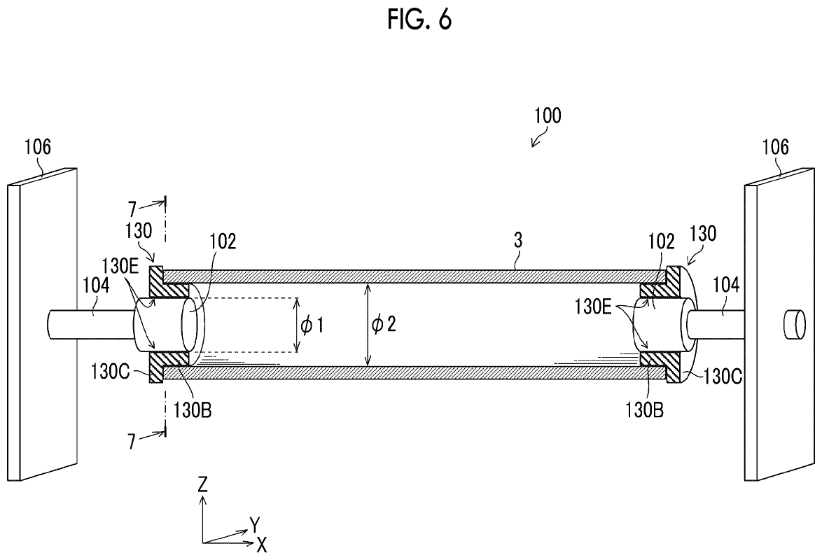

FIG. 6 is a diagram showing a state in which the roll substrate holding device 100 holds the second paper tube 3. The holding member 102 is inserted into the opening 130A (see FIGS. 4A and 4B) of the conversion adapter 130 that is mounted in advance on the second paper tube 3, and comes into surface contact with an inner peripheral surface 130E (see FIGS. 4A and 4B) of the conversion adapter 130 having the inner diameter φ1, thereby rotatably holding the second paper tube 3. That is, the roll substrate holding device 100 indirectly holds the substrate 1 wound around the second paper tube 3 by fitting the conversion adapter 130 to the holding member 102.

That is, a roll substrate holding method of the present disclosure comprises: a step of mounting the conversion adapter 130 in the opening 3A of the second paper tube 3 having the second inner diameter φ2 larger than the first inner diameter φ1; and a step of inserting the holding member 102 into the opening 130A of the conversion adapter 130 that is mounted on the second paper tube 3, and bringing the holding member 102 into surface contact with the inner peripheral surface 130E of the conversion adapter 130 having the first inner diameter φ1 to rotatably hold the second paper tube 3.

In FIG. 6, an example is shown in which the holding member 102 comes into surface contact with the inner peripheral surface 130E of the conversion adapter 130, but the holding member 102 may come into line contact with the inner peripheral surface 130E of the conversion adapter 130. Since the holding member 102 comes into surface contact or line contact with the inner peripheral surface 130E of the conversion adapter 130, the roll substrate holding device 100 can hold the roll substrate with sufficient strength.

### [Operation of Holding Member in Case of Holding Second Paper Tube]

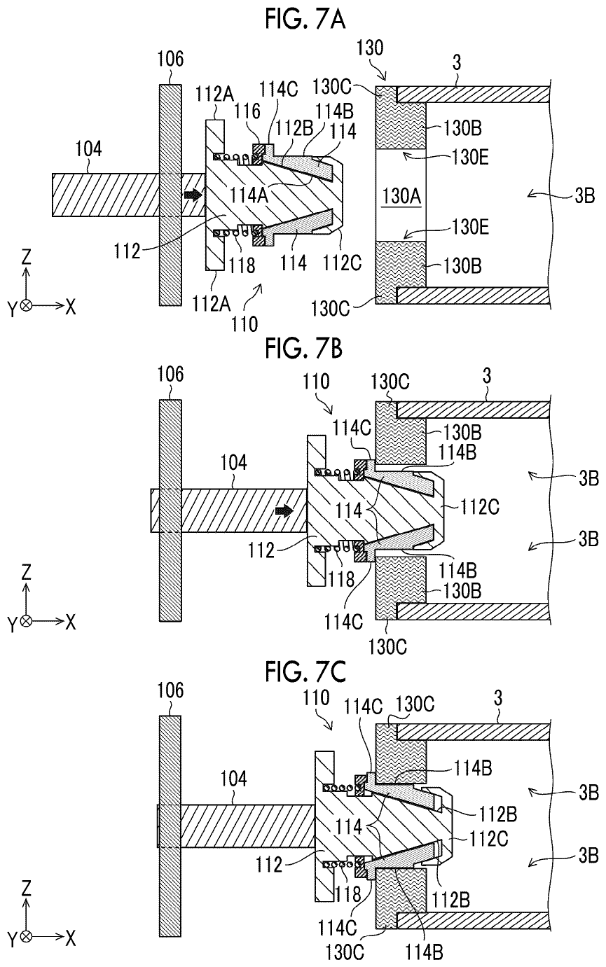

FIGS. 7A to 7C are diagrams for describing an operation of the holding member 102 in a case where the second paper tube 3 is held, and show a 7-7 cross section of FIG. 6. FIG. 7A shows a state before the chuck device 110 is inserted into the opening 130A of the conversion adapter 130, and shows a state in which the chuck device 110 is in a retracted position where the chuck device 110 is retracted from the second paper tube 3. As shown in FIG. 7A, in a case where the chuck device 110 is in the retracted position, the second paper tube 3 is disposed with its axis center aligned with the axis center of the chuck device 110.

From the state shown in FIG. 7A, the rotation and advance/retract mechanism 104 advances the chuck device 110 to the distal end side in the axial direction, and inserts the chuck device 110 into the opening 130A of the conversion adapter 130. FIG. 7B shows a state in which the chuck device 110 is inserted into the opening 130A and the distal end side surface of the flange 114C of the lug 114 abuts on an end surface of the cylindrical portion 130B.

From the state shown in FIG. 7B, the rotation and advance/retract mechanism 104 further advances the chuck device 110 to the distal end side in the axial direction. In this case, since the flange 114C abuts on the end surface of the cylindrical portion 130B of the conversion adapter 130, the lug 114 does not advance, and only the shaft 112 advances against the elastic force of the coil spring 118. Therefore, the lug 114 is expanded radially outward of the chuck device 110 along the tapered surface 112B and protrudes radially outward. The outer peripheral holding surface 114B of the lug 114 protruding radially outward comes into pressure contact (an example of “surface contact”) with the inner peripheral surface 130E of the conversion adapter 130. As a result, the lug 114 and the conversion adapter 130 are fixed, and the chuck device 110 holds the second paper tube 3. FIG. 7C shows a state in which the chuck device 110 is in a mounting position where the chuck device 110 rotatably holds the second paper tube 3 via the conversion adapter 130.

### [Seizing Between Holding Member and Adapter]

In a case of returning the chuck device 110 from the mounting position shown in FIG. 7C to the retracted position shown in FIG. 7A, the rotation and advance/retract mechanism 104 need only retract the chuck device 110 to the base end side in the axial direction. However, in a case where the conversion adapter 130 is used for a long time, the holding member 102 may seize to the inner peripheral surface 130E of the conversion adapter 130, making it difficult to detach the conversion adapter 130 from the holding member 102.

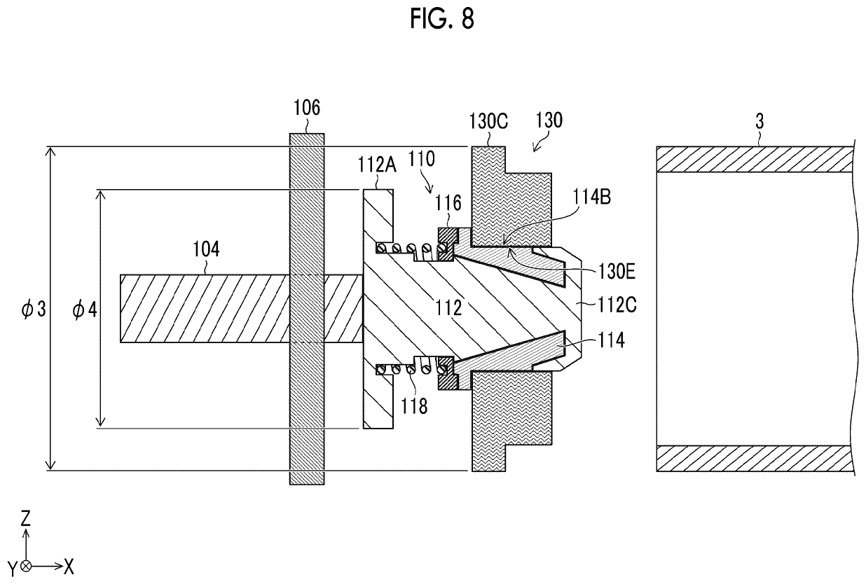

FIG. 8 is a diagram showing a state in which the conversion adapter 130 is not detached from the chuck device 110, in a case where the rotation and advance/retract mechanism 104 retracts the chuck device 110 to the base end side in the axial direction from the state shown in FIG. 7C. As shown in FIG. 8, the conversion adapter 130 moves together with the chuck device 110 while remaining fitted to the lug 114, and is removed from the second paper tube 3.

Here, the outer diameter φ3 of the flange portion 130C is larger than an outer diameter φ4 (an example of an “outer diameter of the holding member”) of the flange 112A, which is an outer diameter of the chuck device 110. Therefore, in the state shown in FIG. 8, a user can hook a his/her finger on the flange portion 130C from the distal end side of the chuck device 110 in the axial direction, making it easy to pull out the conversion adapter 130 from the chuck device 110.

### [Restricting Member]

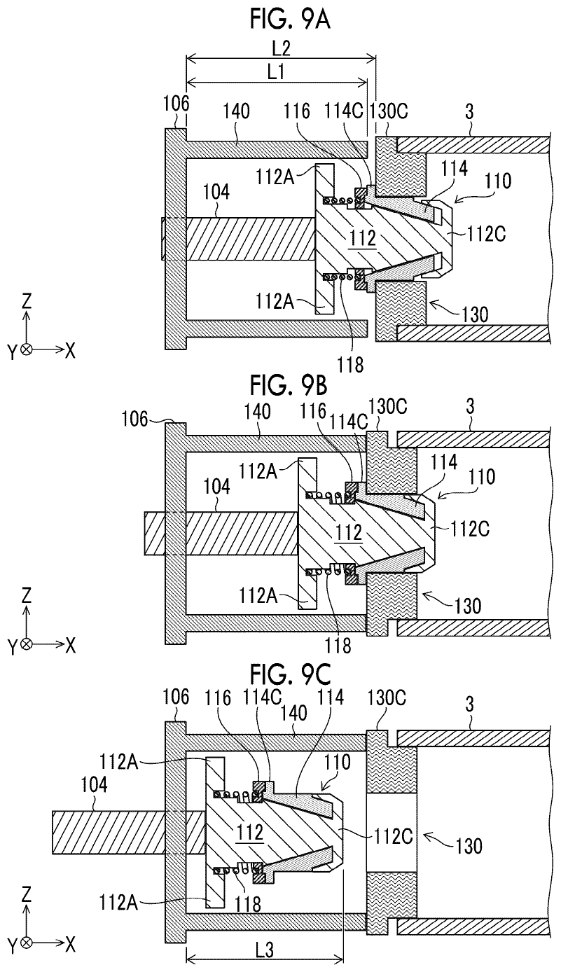

The roll substrate holding device 100 may comprise a restricting member that regulates the movement of the conversion adapter 130 in a case where the holding member 102 is moved from the mounting position to the retracted position and removes the conversion adapter 130 from the holding member 102. FIGS. 9A to 9C are diagrams for describing a configuration and an action of the restricting member.

As shown in FIGS. 9A to 9C, a tension rod 140, which is an example of a restricting member, is a rod-shaped member that is always fixed to the frame 106. One end of the tension rod 140 abuts on the frame 106 and the other end abuts on the conversion adapter 130 and restricts the movement of the conversion adapter 130.

The material of the tension rod 140 is preferably a resin member having high abrasion resistance, such as polyoxymethylene polyacetal (POM) resin, so as not to damage the conversion adapter 130, but a metal member such as iron or aluminum may be used.

One or more and four or less tension rods 140 are disposed on the frame 106. Since a single tension rod 140 results in poor balance, it is desirable to dispose two or three tension rods 140. The tension rod 140 is disposed in parallel to the axial direction of the chuck device 110.

A length of the tension rod 140 in the axial direction is preferably shorter than a distance between the frame 106 and the chuck device 110 in the mounting position and longer than a distance between the chuck device 110 and the frame 106 in the retracted position. Specifically, a length L1 of the tension rod 140 in the axial direction is shorter than a distance L2 from a position where the chuck device 110 and the conversion adapter 130 are in contact with each other (the distal end side surface of the flange 114C of the lug 114) to the frame 106 at a position where the chuck device 110 is most advanced (for example, the mounting position). In addition, the length L1 of the tension rod 140 in the X direction is longer than a distance L3 from the distal end of the chuck device 110 (the distal end side surface of the cap portion 112C) to the frame 106 at a position where the chuck device 110 is most retracted (for example, the retracted position).

FIG. 9A shows a state in which the chuck device 110 is in a mounting position where the chuck device 110 rotatably holds the second paper tube 3 via the conversion adapter 130. In this state, the tension rod 140 is not in contact with the conversion adapter 130.

From the state shown in FIG. 9A, the rotation and advance/retract mechanism 104 retracts the chuck device 110 to the base end side in the axial direction. FIG. 9B shows a case where the chuck device 110 is retracted to the base end side in the axial direction by the rotation and advance/retract mechanism 104. In the state shown in FIG. 9B, the lug 114 and the conversion adapter 130 are seized and fixed together, and the conversion adapter 130 is moved to the base end side together with the chuck device 110 without being detached from the chuck device 110. In addition, in the state shown in FIG. 9B, the conversion adapter 130 abuts on the tension rod 140.

From the state shown in FIG. 9B, the rotation and advance/retract mechanism 104 further retracts the chuck device 110 to the base end side in the axial direction. In this case, since the conversion adapter 130 abuts on the tension rod 140, the conversion adapter 130 is not retracted, and only the chuck device 110 is retracted to the base end side.

FIG. 9C shows a state in which the chuck device 110 is moved to the retracted position by the rotation and advance/retract mechanism 104. In the state shown in FIG. 9C, the conversion adapter 130 is removed from the chuck device 110.

In this way, in a case where the chuck device 110 is moved in the retracted position direction from the mounting position, and in a case where the conversion adapter 130 is moved together with the chuck device 110, the tension rod 140 abuts on the flange portion 130C of the conversion adapter 130, the movement of the conversion adapter 130 is restricted, and the conversion adapter 130 is detached from the chuck device 110.

The restricting member is not limited to the shape of the tension rod 140. For example, it is desirable in terms of design that the restricting member has a cylindrical shape that extends in the axial direction and that covers the holding member 102. In addition, here, an example in which the restricting member is fixed to the frame 106 has been described, but the restricting member may be integrated with the conversion adapter 130. In addition, the restricting member may be a separate jig-like member that is disposed between the frame 106 and the conversion adapter 130 only in a case where the holding member 102 is moved to the retracted position.

### <Others>

The technical scope of the present invention is not limited to the scope described in the above embodiment. The configurations and the like in each embodiment can be appropriately combined among the respective embodiments without departing from the spirit of the present invention.

### EXPLANATION OF REFERENCES

1: substrate
2: first paper tube
2A: opening
2B: inner peripheral surface
3: second paper tube
3A: opening
3B: inner peripheral surface
10: inkjet printing apparatus
20: transport unit
22: unwinding unit
24: winding unit
26: pass roller
30: jetting unit
32C: ink jet head
32K: ink jet head
32M: ink jet head
32Y: ink jet head
40: drying unit
100: roll substrate holding device
102: holding member
104: rotation and advance/retract mechanism
106: frame
110: chuck device
112: shaft
112A: flange
112B: tapered surface
112C: cap portion
114: lug
114A: tapered surface
114B: outer peripheral holding surface
114C: flange
116: receiving member
130: conversion adapter
130A: opening
130B: cylindrical portion
130C: flange portion
130D: triangular mountain-like protrusion
130E: inner peripheral surface
140: tension rod

What is claimed is:

1. A roll substrate holding device that holds a roll substrate wound around a winding core without using a shaft, the roll substrate holding device comprising:
a holding member that is inserted into an opening of a first winding core having a first inner diameter and that comes into contact with the first winding core to rotatably hold the first winding core; and
a conversion adapter that is mounted in an opening of a second winding core having a second inner diameter larger than the first inner diameter,
wherein an inner diameter of an opening of the conversion adapter is the first inner diameter,
the holding member is inserted into the opening of the conversion adapter that is mounted in advance on the second winding core, and comes into surface contact or line contact with an inner peripheral surface of the conversion adapter having the first inner diameter to rotatably hold the second winding core,
the conversion adapter has a flange portion provided around an entire circumference of an end portion thereof, and
an outer diameter of the flange portion is larger than the second inner diameter.

2. The roll substrate holding device according to claim 1,
wherein the outer diameter of the flange portion is larger than an outer diameter of the holding member.

3. The roll substrate holding device according to claim 2, further comprising:
an attachment/detachment mechanism that moves the holding member in an axial direction of the second winding core between a mounting position where the holding member is inserted into the opening of the conversion adapter and a retracted position where the holding member is retracted from the opening of the conversion adapter; and
a restricting member that restricts movement of the conversion adapter in a case where the holding member is moved from the mounting position to the retracted position.

4. The roll substrate holding device according to claim 3,
wherein the restricting member has one end abutting on a frame and the other end abutting on the conversion adapter and restricts movement of the conversion adapter, and
a length of the restricting member in the axial direction is shorter than a distance between the frame and the holding member in the mounting position, and is longer than a distance between the holding member and the frame in the retracted position.

5. The roll substrate holding device according to claim 3,
wherein the restricting member includes one or more and four or less rod-shaped members extending in the axial direction.

6. The roll substrate holding device according to claim 3,
wherein the restricting member includes a tubular member extending in the axial direction and covering the holding member.

7. The roll substrate holding device according to claim 3,
wherein the restricting member is a resin member or a metal member.

8. The roll substrate holding device according to claim 4,
wherein the restricting member is fixed to the frame.

9. The roll substrate holding device according to claim 3,
wherein the restricting member is integrated with the conversion adapter.

10. The roll substrate holding device according to claim 1,
wherein the holding member includes a mechanical chuck that brings a pressing member into pressure contact with an inner peripheral surface of the first winding core.

11. The roll substrate holding device according to claim 1,
wherein the roll substrate holding device is provided with
a pair of the holding members that are inserted into openings at both ends of the first winding core, and
a pair of the conversion adapters that are mounted in the openings at both ends of the first winding core.

12. A printing apparatus that transports a substrate by using a roll-to-roll method, the printing apparatus comprising:
the roll substrate holding device according to claim 1; and
a jetting device that jets ink from an ink jet head onto the substrate to print an image.

13. A roll substrate holding method of holding a roll substrate wound around a winding core without a shaft, the roll substrate holding method comprising:
a step of mounting a conversion adapter in an opening of a second winding core having a second inner diameter larger than a first inner diameter, the conversion adapter having a flange portion provided around an entire circumference of an end portion thereof, wherein an outer diameter of the flange portion is larger than the second inner diameter; and
a step of inserting, into an opening of the conversion adapter that is mounted in advance on the second winding core, a holding member that is inserted into an opening of a first winding core having the first inner diameter and that comes into contact with the first winding core to rotatably hold the first winding core, and bringing the holding member into surface contact or line contact with an inner peripheral surface of the conversion adapter having the first inner diameter to rotatably hold the second winding core.
